(19) United States
(12) Patent Application Publication
(10) Pub. No.: US 2026/0301671 A1
(43) Pub. Date: Oct. 1, 2026

(54) Display Device and Driving Method of the Display Device

(71) Applicant: LG Display Co., Ltd., Seoul (KR)

(72) Inventors: Soekmin Choi, Paju-si (KR); Mookyoung Hong, Paju-si (KR)

(21) Appl. No.: 19/401,927

(22) Filed: Nov. 26, 2025

(30) Foreign Application Priority Data
Mar. 28, 2025 (KR) 10-2025-0040492

(51) Int. Cl. G09G 3/3233

(52) U.S. Cl. CPC G09G 3/3233; G09G 2300/0842; G09G 2320/0233; G09G 2320/0247; G09G 2320/043; G09G 2330/021; G09G 2340/0435

(57) ABSTRACT

A display device and a method for operating the display device are presented herein. The display device includes a display panel having an arrangement of a plurality of pixels, a gate driver configured to apply a scan signal to a first pixel of the plurality of pixels, a data driver configured to apply a data voltage to the first pixel, a power supply unit configured to apply a reference voltage to the first pixel, and a timing controller configured to control an operation of the data driver and the power supply unit. The reference voltage may be varied based on at least one among an driving mode of the display panel, a degree of deterioration of the first pixel, and a driving frequency of the first pixel.

### CROSS-REFERENCE TO RELATED APPLICATION

The present application claims priority to Republic of Korea Patent Application No. 10-2025-0040492, filed Mar. 28, 2025, which is incorporated herein by reference in its entirety.

### FIELD

The present disclosure relates to a display device and a method for driving the same.

### BACKGROUND

With the progress of the information-oriented society, various types of demands for display devices which display an image are increasing. Further, various types of display devices such as a liquid crystal display device, and an organic light emitting display device have been used.

The images displayed in the display device may be still images or moving images. If the images are moving images, the images may be various kinds such as sports images, game images, movies, and the like. The display device may be driven in a variable refresh rate mode (VRR) in which a driving frequency is varied according to the kinds of the image and therefore, power consumption can be reduced and a use lifespan of the display device can extend.

When driving the pixels at various refresh rates by applying the variable refresh rate mode (VRR), a luminance difference may be generated among the pixels by the different refresh rates, and this may lead to quality deterioration such as image distortion or flicker.

### SUMMARY

Embodiments of the present disclosure provide a display device which varies a reference voltage applied to an anode electrode of the light emitting element in the variable refresh rate mode and a method for driving the same.

Embodiments of the present disclosure provide a display device configured to set a voltage value of a remainder range except pre-allocated grayscale voltage range and compensation voltage range as a reference voltage in a voltage range of a data voltage and a method for driving the same.

Embodiments of the present disclosure provide a display device configured to vary the remainder range according to the driving mode of the display device and vary the reference voltage in correspondence with the varied remainder range and a method for driving the same.

Embodiments of the present disclosure provide a display device configured to allocate a remaining compensation voltage range for the reference voltage when part of the compensation voltage range is used as the compensation voltage according to a degree of deterioration of the display device and a method for driving the same.

Embodiments of the present disclosure provide a display device configured to set a value obtained by adding a remaining voltage value except a voltage value allocated as the compensation voltage and a voltage value of the remainder range in the compensation voltage range as the reference voltage and a method for driving the same.

Embodiments of the present disclosure provide a display device configured to vary the reference voltage in proportion to the driving frequency which is varied in the variable reference rate mode and a method for driving the same.

Embodiments of the present disclosure provide a display device configured to vary the data voltage in correspondence with a change amount (an offset) of the reference voltage and a method for driving the same.

In one or more embodiments of the present disclosure, a display device includes: a display panel having an arrangement of a plurality of pixels; a gate driver configured to apply a scan signal to a first pixel of the plurality of pixels; a data driver configured to apply a data voltage to the first pixel; a power supply unit configured to apply a reference voltage to the first pixel; and a timing controller configured to control an operation of the data driver and the power supply unit.

The reference voltage may be varied based on at least one among an driving mode of the display device, a degree of deterioration of the first pixel and a driving frequency of the first pixel.

The driving frequency may be varied according to a variable refresh rate mode.

In the variable refresh rate mode, the pixels may be driven on a frame basis.

The frame may include: an active period in which the data voltage is programmed into the pixels; and a blank period in which the programming of the data voltage is omitted and a length thereof is varied according to the driving frequency.

The driving mode may include a high dynamic range (HDR) mode and a standard dynamic range (SDR) mode, and in a condition of a same driving frequency, a voltage value of the reference voltage in the HDR mode may be greater than a voltage value of the reference voltage in the SDR mode.

The voltage value of the reference voltage may increase or decrease in proportion to the driving frequency in a condition of a same driving mode.

The voltage value of the data voltage may be set in a preset voltage range, and the voltage range may include: a grayscale voltage range, a compensation voltage range and a remainder range.

The voltage value of the reference voltage may be set to a value corresponding to the remainder range which is varied according to the driving mode.

The compensation voltage may be set in the compensation voltage range and the reference voltage may be further varied in correspondence with a change amount of the compensation voltage.

A voltage value of the reference voltage may be set by adding a remaining range of the compensation voltage range which is not used for the compensation voltage to the remainder range.

The compensation voltage range further allocated to the reference voltage may include at least one among a mobility compensation range, a positive polarity compensation margin range, and a negative polarity compensation margin range of a driving element provided in the pixels.

A voltage value of the reference voltage may increase or decrease in proportion to the driving frequency in the remainder range.

Each of the pixels may include: a light emitting element; a driving transistor having a first electrode connected to a high potential driving voltage, a second electrode connected to the light emitting element through a second node, and a gate electrode connected to a first node; a first transistor connected between the data voltage and the second node and configured to receive a first scan signal through a gate electrode; and a second transistor connected between the reference voltage and the second node and configured to receive a second scan signal through a gate electrode.

The data voltage may be varied in correspondence with a change amount of the reference voltage.

In one or more other embodiments of the present disclosure, a method for driving the display device includes: allowing the timing controller to apply the first scan signal in a turn-on level and the second scan signal in a turn-on level in a first period of an active period within one frame; changing the first scan signal and the second scan signal over to a turn-off level in a second period; allowing the light emitting element to be turned on and emit light in a third period; and allowing the light emitting element to emit light in a blank period after the active period.

A length of the blank period may be varied according to the driving frequency, and the reference voltage may be varied on the frame basis based on at least one among the driving mode, the degree of deterioration and the driving frequency of the pixels.

A voltage value of the data voltage may be set in a preset voltage range, and the voltage range may include: a grayscale voltage range, a compensation voltage range and a remainder range.

The voltage value of the reference voltage may be set to a value corresponding to the remainder range.

The driving mode may include a high dynamic range (HDR) mode and a standard dynamic range (SDR) mode.

In a condition of a same driving frequency, a voltage value of the reference voltage in the HDR mode may be greater than a voltage value of the reference voltage in the SDR mode.

The voltage value of the reference voltage may increase or decrease in proportion to the driving frequency in a condition of a same driving mode.

The compensation voltage may be set in the compensation voltage range, and the reference voltage may be further varied in correspondence with a change amount of the compensation voltage.

A voltage value of the reference voltage may be set by adding a remaining range of the compensation voltage range which is not used for the compensation voltage to the remainder range.

The compensation voltage range further allocated to the reference voltage may include at least one among a mobility compensation range, a positive polarity compensation margin range, and a negative polarity compensation margin range of a driving element provided in the pixels.

A voltage value of the reference voltage may increase or decrease in proportion to the driving frequency in the remainder range.

A display device and a method for driving the same according to the embodiments may prevent flicker and flashing phenomena when changing the driving frequency in the variable refresh rate mode.

In one or more other embodiments of the present disclosure, a display device includes a display panel having an arrangement of a plurality of pixels, a gate driver, a data driver, a power supply unit, and a timing controller. A first pixel of the plurality of pixels includes a light emitting element configured to emit light, a driving transistor having a gate electrode connected to a first node, the driving transistor connected to the light emitting element through a second node, a first transistor having a first electrode connected to a data line, a second electrode connected to the first node and a gate electrode connected to a first gate line, and a second transistor having a first electrode connected to a reference voltage line, a second electrode connected to the second node and a gate electrode connected to a second gate line.

The gate driver is configured to provide a first scan signal to the first gate line and a second scan signal to the second gate line, the data driver is configured to provide a data voltage to the data line, the power supply unit configured to provide a reference voltage to the reference voltage line, and the timing controller configured to control an operation of the data driver and the power supply unit. The timing controller controls the power supply unit to vary the reference voltage based on at least one among a driving mode of the display device, a degree of deterioration of the first pixel, and a driving frequency of the first pixel.

The timing controller may control the power supply unit to increase the reference voltage when the driving frequency changes from a first frequency to a second frequency greater than the first frequency.

The timing controller may control the power supply unit to decrease the reference voltage when the driving frequency changes from the second frequency to the first frequency.

A display device and a method for driving the same according to the embodiments of the present disclosure may allow the light emitting element to reach the driving voltage fast during the display operation by raising of the reference voltage.

A display device and a method for driving the same according to the embodiments of the present disclosure may reduce a turn-on time of the light emitting element and increase a light emitting period, thereby increasing an integral amount of luminance and recognition luminance at a high frequency and minimizing or at least reducing a difference from the recognition luminance at a low frequency.

A display device and a method for driving the same according to the embodiments of the present disclosure may improve image quality of a low grayscale image in which the flicker and flashing phenomena are particularly easily visible.

A display device and a method for driving the same according to the embodiments of the present disclosure may prevent malfunction and image quality deterioration of the display device by preventing boost of the data voltage in correspondence with the reference voltage from exceeding a preset voltage range.

### BRIEF DESCRIPTION OF THE DRAWINGS

FIG. 1 is a block diagram of a configuration of a display device according to one or more embodiments of the present disclosure.

FIG. 2 is a circuit diagram of a pixel according to one or more embodiments of the present disclosure.

FIG. 3 is a diagram illustrating a method for driving a pixel according to one or more embodiments of the present disclosure.

FIG. 4 is a diagram illustrating a voltage range of a data voltage according to one or more embodiments of the present disclosure.

FIG. 5 is a diagram illustrating a method for driving a variable refresh rate according to one or more embodiments of the present disclosure.

FIG. 6 is a diagram illustrating a difference in an integral amount of luminance according to a refresh rate according to one or more embodiments of the present disclosure.

FIG. 7 is a diagram illustrating variation of recognition luminance according to a change of a refresh rate according to one or more embodiments of the present disclosure.

FIG. 8 is a diagram illustrating a method for driving a pixel according to one or more embodiments of the present disclosure.

FIG. 9 is a diagram illustrating an effect of improving a difference in an integral amount of luminance according to variation of a reference voltage according to one or more embodiments of the present disclosure.

FIG. 10 is a diagram illustrating an effect of improving variation of recognition luminance according to variation of a reference voltage according to one or more embodiments of the present disclosure.

FIG. 11 is a diagram illustrating a method for setting a variable reference voltage according to a first embodiment of the present disclosure.

FIG. 12 is a diagram illustrating a method for setting a variable reference voltage according to a second embodiment of the present disclosure.

FIG. 13 is a diagram illustrating a method for setting a variable reference voltage according to a third embodiment of the present disclosure.

FIG. 14 is a block diagram illustrating a connection relationship among a timing controller, a data driver, and a power supply unit according to one or more embodiments of the present disclosure.

### DETAILED DESCRIPTION

Hereinafter, embodiments of the present disclosure will be described with reference to the drawings. In the present disclosure, when a component (or, an area, a layer, a part, etc.) is referred to as being “on”, “connected to” or “combined to” another component, the component may be directly on, connected to, or combined to the other component, or a third component therebetween may be present.

Like reference numerals refer to like elements throughout. Additionally, in the drawings, the thicknesses, proportions, and dimensions of components may be exaggerated for ease of description and clarity. “And/or” includes all of one or more combinations defined by related components.

It will be understood that when the terms “first” and “second” are used herein to describe various components, these components should not be limited by these terms. The above terms are used only to distinguish one component from another. For example, a first component may be referred to as a second component and vice versa without departing from the scope of the present disclosure. Singular expressions and terms used herein also encompass or include plural expressions and terms, unless the context clearly indicates otherwise.

Spatially relative terms, such as “beneath,” “below,” “lower,” “above,” “upper” and the like, may be used herein for ease of description to describe one element or feature's relationship to another element(s) or feature(s) as illustrated in the drawings. The above terms are relative concepts and are explained based on the directions indicated in the drawing.

In various embodiments of the present disclosure, the term “include,” “comprise,” “including,” or “comprising,” specifies a property, a fixed number, a step, a process, an element and/or a component, or a combination thereof, but does not exclude presence or addition of other properties, fixed numbers, steps, processes, elements and/or components, or a combination thereof.

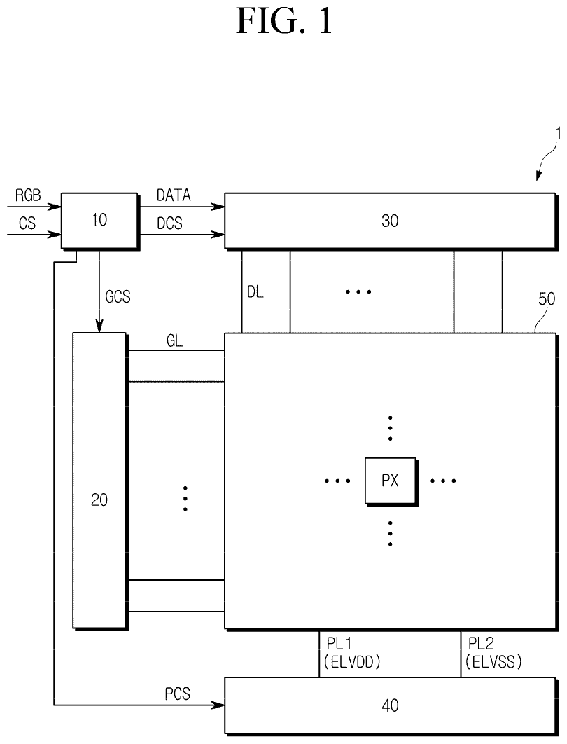

FIG. 1 is a block diagram of a configuration of a display device according to one or more embodiments of the present disclosure.

Referring to FIG. 1, the display device 1 may include a timing controller 10, a gate driver 20, a data driver 30, a power supply unit 40, and a display panel 50.

The timing controller 10 may be configured by being integrated to various processors, for example, a micro-processor, a mobile processor, an application processor, and the like according to devices mounted therein.

The timing controller 10 may receive a video signal RGB and a control signal CS from an external host system and the like. The video signal RGB may include a plurality of grayscale data. The control signal CS may include, for example, a horizontal synchronization signal, a vertical synchronization signal and a main clock signal.

The timing controller 10 processes the video signal RGB and the control signal CS to be suitable to driving conditions of the display panel 50, and may generate and output image data DATA, a gate driving control signal GCS, a data driving control signal DCS, and a power supply control signal PCS.

The gate driver 20 may generate scan signals based on a gate driving control signal output from the timing controller 10. The gate driver 20 may provide the generated scan signals to the pixels PX through a plurality of gate lines GL. In one or more embodiments, one pixel PX may be configured to receive a plurality of scan signals having different waveforms. In such cases, the gate driver 20 may provide the plurality of scan signals to the pixels PX through the gate lines GL corresponding thereto, respectively.

The gate driver 20 may be configured in a Gate-In-Panel form in which the gate driver 20 is mounted on the display panel 50. The gate driver 20 may be disposed on one side of the display panel 50, or on both sides (for example, left and right sides) of the display panel 50. According to a driving method, a panel design manner, and the like, the gate driver 20 may be disposed on both sides (for example, left and right sides) of the display panel 50, or may be connected to two or more side surfaces among four side surfaces of the display panel 50.

The data driver 30 may generate data signals based on the data driving control signal DCS and image data DATA output from the timing controller 10. The data driver 30 may provide the generated data signals to the pixels PX through a plurality of data lines DL.

The power supply unit 40 may generate a high potential driving voltage ELVDD and a low potential driving voltage ELVSS to be provided to the display panel 50 based on the power supply control signal PCS. The power supply unit 40 may provide the generated driving voltages ELVDD and ELVSS to the pixels PX through corresponding power lines PL1 and PL2. In addition, the power supply unit 40 may further generate a reference voltage and the like required for driving the pixel PX, and provide it to the pixels PX through a corresponding voltage line.

The display panel 50 may be implemented as a transmissive or a non-transmissive display panel. The transmissive display panel may be applied to a transparent display device of which an image is displayed in the screen and a real background object is visible. The display panel 50 may be manufactured as a flexible display panel. The flexible display panel may be implemented as an OLED panel which uses a plastic substrate.

On the display panel 50, a plurality of pixels PX (or referred to as sub-pixels) is disposed. The pixels PX may be disposed, for example, in a matrix form on the display panel 50. The pixels disposed in one pixel row are connected to the same gate line GL, and the pixels PX disposed in one pixel column are connected to the same data line DL. The pixels PX may emit light at luminance corresponding to a data signal and a scan signal supplied through the gate line GL and the data line DL.

Each pixel PX may include the light emitting element and a driving circuit configured to drive the light emitting element. The light emitting element included in the pixel PX may display one color among red, green and blue. In one or more other embodiments, the light emitting element may display one color among cyan, magenta and yellow. In various embodiments, the light emitting element may display one color among red, green, blue and white.

In one or more embodiments, a touch sensor may be further disposed on the display panel 50. A touch input may be sensed using additional touch sensors or may be sensed through pixels PX. The touch sensors may be disposed on the screen of the display panel 50 in an on-cell type or an add-on type, or may be implemented as in-cell type touch sensors embedded to the display panel 50.

The timing controller 10, the gate driver 20, the data driver 30 and the power supply unit 40 may be configured as separate Integrated Circuits (IC) or at least some parts thereof together may be integrated into and form the Integrated Circuit.

In one or more embodiments, the display device 1 may operate in a variable refresh rate mode in which a driving frequency variation is possible. For example, the display device 1 may operate in a refresh rate higher or lower than a predetermined reference refresh rate. The driving of the display device 1 at a refresh rate lower than the reference refresh rate may be referred to as ‘low-speed driving’, and the driving of the display device 1 at a refresh rate higher than the reference refresh rate may be referred to as ‘high-speed driving’. The refresh rate may be determined according to kinds of displayed images and the like, but is not limited thereto.

The timing controller 10 may generate control signals so that the pixel PX can operate at various refresh rates. For example, the timing controller 10 may vary the refresh rate by changing a frequency of a clock signal included in the control signals, or adjusting a timing of the horizontal synchronization signal or the vertical synchronization signal, or driving the gate driver 20 in a mask manner.

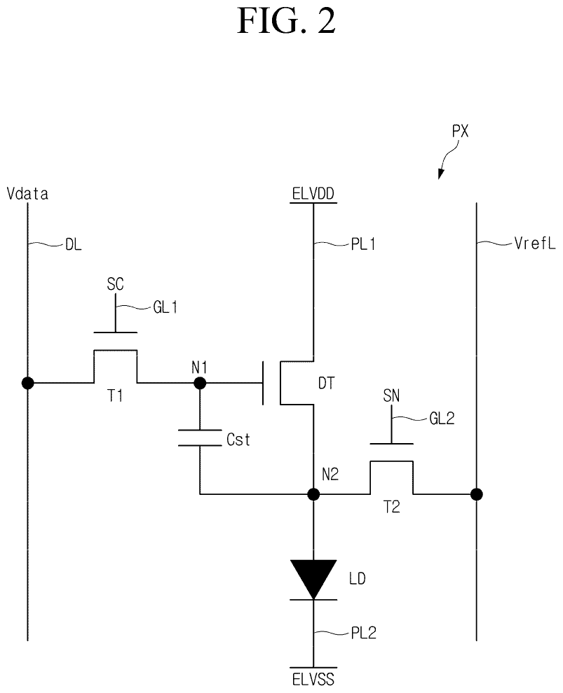

FIG. 2 is a circuit diagram of the pixel according to one or more embodiments of the present disclosure.

Referring to FIG. 2, the pixel PX according to one or more embodiments may include a driving transistor DT, a light emitting element LD connected to the driving transistor DT, and a control circuit configured to control an amount of a driving current to be applied to the light emitting element LD through the driving transistor DT. For example, the control circuit may include transistors T1 and T2, and a storage capacitor Cst.

A first electrode of the driving transistor DT is configured to receive a high potential driving voltage ELVDD (connected to a high potential driving voltage line PL1), and a second electrode thereof is connected to the light emitting element through a second node N2. A gate electrode of the driving transistor DT is connected to the data line DL through a first node N1. The driving transistor DT may be turned on according to a voltage difference between the first node N1 and the second node N2 (that is, a gate-source voltage) and may control an amount of the driving current flowing to the light emitting element LD.

The first electrode of the first transistor T1 is connected to the data line DL, and the second electrode thereof is connected to the gate electrode of the driving transistor DT through the first node N1. A gate electrode of the first transistor T1 may be connected to a first gate line GL1 and may receive a first gate signal. The first gate signal is a scan signal SC, and may be a control signal applied so as to program a data voltage Vdata into the pixel PX.

The first transistor T1 may be turned on according to the scan signal SC applied to the first gate line GL1, and may deliver a data voltage Vdata applied to the data line DL to the first node N1. Such a first transistor T1 may be referred to as a switching transistor.

A first electrode of the second transistor T2 is connected to a reference voltage line VrefL, and a second electrode thereof is connected to the second node N2. A gate electrode of the second transistor T2 may be connected to a second gate line GL2 and may receive a second gate signal. A second gate signal is a sensing signal SN, and may be a control signal applied so as to apply a reference voltage to the pixel PX, or sense an electric characteristic of the pixel PX.

The second transistor T2 may be turned on according to the sensing signal SN applied to the second gate line GL2, and may electrically connect the reference voltage line VrefL and the second node N2 to each other. When the reference voltage Vref is applied to the reference voltage line VrefL, the reference voltage Vref may be applied to the second node N2 through the second transistor T2 turned on.

When the reference voltage Vref is not connected to the reference voltage line VrefL, a sensing signal (for example, a current, a voltage) applied to the second node N2 may flow through the reference voltage line VrefL to be delivered to the data driver 30 (FIG. 1) and/or the timing controller 10 (FIG. 1). The delivered sensing signal may be used to sense an electric characteristic of the pixel PX. Such a second transistor T2 may be referred to as an initialization transistor and/or a sensing transistor.

The storage capacitor Cst is connected between the first node N1 and the second node N2. The storage capacitor Cst may store a voltage corresponding to a voltage difference between the first node N1 and the second node N2, and maintain the stored voltage during one frame period, thereby stabilizing a voltage of the gate electrode (that is, the first node N1) of the driving transistor DT.

The anode electrode of the light emitting element LD may be connected to the driving transistor DT, and the cathode electrode thereof may be connected to the low potential driving voltage ELVSS (connected to the low potential driving voltage line PL2). When the driving transistor DT is turned on, a current path is formed between the high potential driving voltage ELVDD and the low potential driving voltage ELVSS, and a driving current may flow to the light emitting element LD. The light emitting element LD may emit light at luminance corresponding to an amount of the driving current applied thereto.

In the embodiment illustrated in FIG. 2, the pixel PX may include an oxide semiconductor transistor. The oxide semiconductor transistor includes a gate electrode, a source electrode, and a drain electrode. The oxide semiconductor transistor has an active layer formed of an oxide semiconductor. Here, the oxide semiconductor may be set as an amorphous oxide semiconductor or a crystalline oxide semiconductor. The oxide semiconductor transistor may be configured as an n-type transistor. The oxide semiconductor transistor may be formed through a low temperature process and has a lower charge mobility than that of the LTPS transistor. Such an oxide semiconductor transistor has an excellent off current characteristic.

In one or more other embodiments, the pixel PX may be a hybrid type further including the LTPS (Low Temperature Poly-Silicon) transistor.

The LTPS transistor includes a gate electrode, a source electrode, and a drain electrode. The LTPS transistor has an active layer formed of poly silicon. The LTPS transistor includes an active layer formed of poly silicon. Such an LTPS transistor may be configured as a P-type transistor or an N-type transistor. The LTPS transistor has a high electron mobility, and therefore, has a fast driving characteristic.

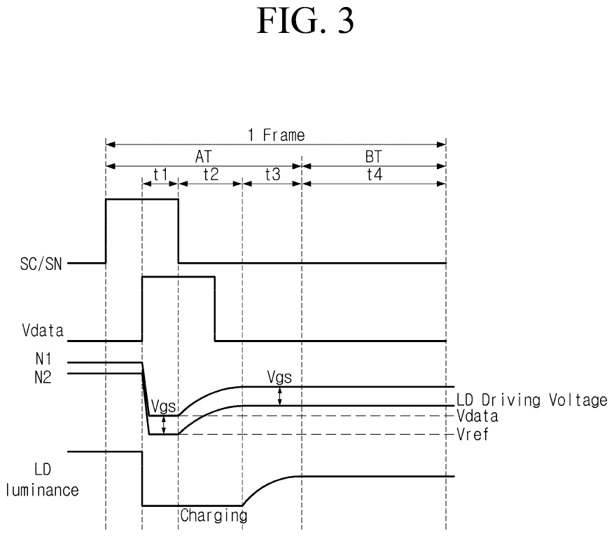

FIG. 3 is a diagram illustrating a method for driving the pixel illustrated in FIG. 2.

Referring to FIGS. 2 and 3 together, the pixel PX may be driven on a frame basis. One frame may include an active period AT in which an image is displayed and a blank period BT after the active period.

In the active period AT, the data voltage Vdata is programmed into the pixel PX, and the light emitting element LD may emit light at luminance corresponding to the data voltage Vdata. In such an embodiment, the active period AT may be referred to as a refresh period in which the data voltage Vdata is programmed.

The active period AT may include a programming period t1, a boosting period t2, and a light emitting period t3.

In the programming period t1, the first transistor T1 may be turned on by the scan signal SC in a turn-on level, and the second transistor T2 may be turned on by the sensing signal SN in a turn-on level. In the programming period t1, the reference voltage Vref may be applied to the reference voltage line VrefL, and the data voltage Vdata may be applied to the data line DL.

Accordingly, the data voltage Vdata may be applied to the first node N1 of the driving transistor DT, and the reference voltage Vref may be applied to the second node N2 thereof. That is, in the programming period t1, the gate-source voltage of the driving transistor DT is programmed as a voltage difference between the data voltage Vdata and the reference voltage Vref. The programmed voltage may be stored in the storage capacitor Cst. At this instance, the gate-source voltage has a value greater than the threshold voltage of the driving transistor DT, and the driving transistor DT may be turned on.

In the boosting period t2, the scan signal SC and the sensing signal SN are changed over to a turn-off level and the first and second transistors T1 and T2 are turned off. Then, the driving current may be applied to the second node N2 through the driving transistor DT in a turn-on state. A voltage of second node N2 may gradually increase by the driving current. At this instance, a voltage of the first node N1 coupled to the second node N2 by the storage capacitor Cst may rise in response to the rise of the voltage of the second node N2. Therefore, the gate-source voltage of the driving transistor DT is maintained as the voltage programmed in the programming period t1.

When a voltage of the second node N2 increases to the driving voltage of the light emitting element LD, the light emitting element LD may be turned on in the light emitting period t3. In the light emitting period t3, the driving current corresponding to the gate-source voltage of the driving transistor DT may flow to the light emitting element LD, and the light emitting element LD may emit light at luminance corresponding to the driving current.

In the blank period BT, the light emitting element LD may emit light in correspondence with the data voltage Vdata previously programmed. That is, the blank period BT may be formed of only the light emitting period t4. In such an embodiment, the blank period BT may be referred to as a skip period or a hold period in which programming of the data voltage Vdata is omitted.

In various embodiments, in the blank period BT, a voltage of the anode electrode of the light emitting element LD may be initialized, or a degree of deterioration of the driving elements, for example, the driving transistor DT and/or the light emitting element LD may be sensed. The degree of deterioration may include, for example, a threshold voltage and mobility of the driving transistor DT, and a degree of change of the driving voltage of the light emitting element LD. At this instance, a certain compensation voltage corresponding to the degree of deterioration may be added to the data voltage Vdata, and the compensated data voltage Vdata may be applied to the pixel PX. In such a manner, mobility of the pixel PX, a sequential threshold voltage Vth and the like may be compensated.

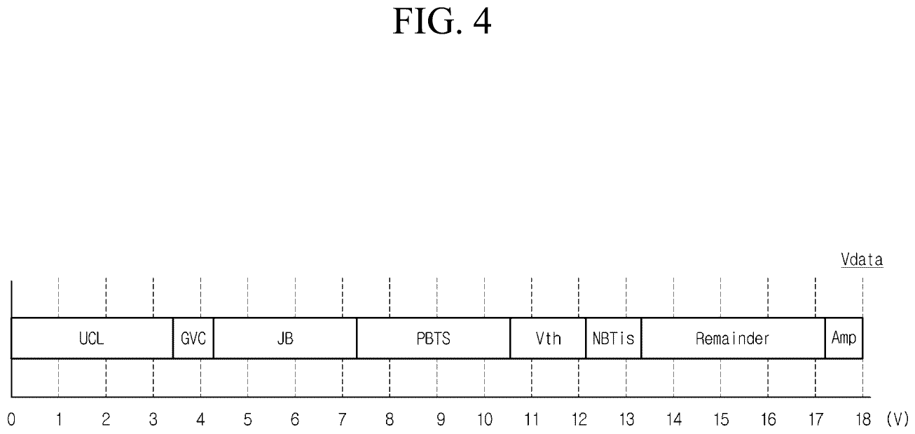

FIG. 4 is a diagram illustrating a voltage range of a data voltage according to one or more embodiments of the present disclosure.

Referring to FIG. 4, a voltage value of the data voltage Vdata may be set in an illustrated voltage range. For example, in the illustrated embodiment, the data voltage Vdata may have a voltage value between 0V to 18V, but is not limited thereto.

The range of each voltage in FIG. 4 represents a magnitude of the maximum voltage value that the corresponding voltage may have from 0V voltage value. For example, a grayscale voltage which will be described below may have a magnitude between 0V to about 3.3V according to a grayscale voltage range UCL, and a gamma compensation voltage may have a magnitude between 0V to about 0.9V according to a gamma compensation range GVC. When all the voltages are allocated as 0V, the data voltage Vdata is set to 0V, and when all the voltages are set to the maximum voltage value, the data voltage Vdata may be set to 18V.

The data voltage Vdata may be determined by adding a compensation voltage based on a degree of deterioration determined through pixel sensing to the grayscale voltage determined by a grayscale value. At this instance, the grayscale voltage range UCL and the compensation voltage range may be allocated respectively in the entire voltage range so that a value obtained by adding the grayscale voltage and the compensation voltage does not exceed 18V, which is the maximum voltage.

A voltage value of the grayscale voltage may be set in the grayscale voltage range UCL. The grayscale voltage range UCL may include voltage levels corresponding to a plurality of grayscales which may be expressed by the display device 1 (FIG. 1).

The compensation voltage may be set in the remaining voltage range except the grayscale voltage range UCL. The compensation voltage range may include, for example, a gamma compensation range GVC, a mobility compensation range JB, a positive polarity compensation margin range PBTS, a sequential threshold voltage compensation range Vth, a negative polarity compensation margin range NBTis, and an amplification margin range Amp.

The gamma compensation range GVC is a voltage margin set to compensate the data voltage Vdata in correspondence with brightness when the brightness of an image is controlled through an external input and the like.

The mobility compensation range JB is a voltage margin set to compensate a change in mobility of the driving element measured at a power-on or power-off sequence, or measured in real time while the display is driven.

The positive and negative polarity compensation margin ranges PBTS and NBTis are voltage margins set to compensate a shifted threshold voltage when a threshold voltage of the driving transistor DT is shifted to a positive polarity or a negative polarity. For example, when the threshold voltage is shifted to the positive polarity, it is possible to increase the data voltage Vdata in the positive polarity compensation margin range PBTS, and when the threshold voltage is shifted to the negative polarity, it is possible to decrease the data voltage Vdata in the negative polarity compensation margin range NBTis.

The sequential threshold voltage compensation range Vth is a voltage margin set to compensate a change of the threshold voltage of the driving transistor DT according to an increase of the driving period.

The amplification margin range Amp is a voltage margin set to amplify the data voltage Vdata.

A voltage range of the data voltage Vdata may include the remainder range except the grayscale voltage range and the compensation voltage range. In one or more embodiments, the grayscale voltage range and the compensation voltage range may be varied according to the driving mode, the degree of deterioration and/or the driving frequency of the display device 1. When the grayscale voltage range and the compensation voltage range are varied, a size of the remainder range may be varied as well.

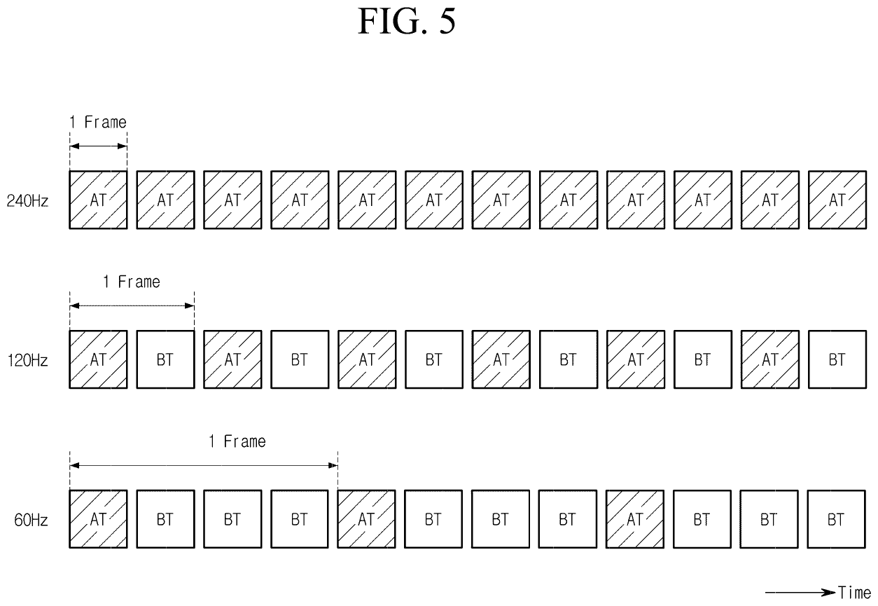

FIG. 5 is a diagram illustrating a method for driving the variable refresh rate according to one or more embodiments of the present disclosure.

In the variable refresh rate mode, a length of one frame illustrated in FIG. 3 is varied. For example, as the length of the active period AT and/or the blank period BT is varied in one frame, the length of one frame may be varied.

As the length of the one frame is varied, a programming interval of the data voltage Vdata, that is, a generation interval of the active period AT may be varied. The generation interval of the active period AT may be elongated as the refresh rate is low, and a length of the blank period BT between the active periods AT may be elongated as the refresh rate is low.

For example, in the illustrated embodiment, the generation interval of the active period AT may be 1 sec/240(one time) at 240 Hz, 1 sec/120(twice) at 120 Hz, and 1 sec/60(four times) at 60 Hz. That is, a length of one frame may be one time at 240 Hz, twice at 120 Hz, and four times at 60 Hz. A length of the blank period BP positioned between two adjacent active periods AT may increase in correspondence with the length of the frame and the generation interval of the active period AT. However, the embodiments of the present disclosure are not limited thereto.

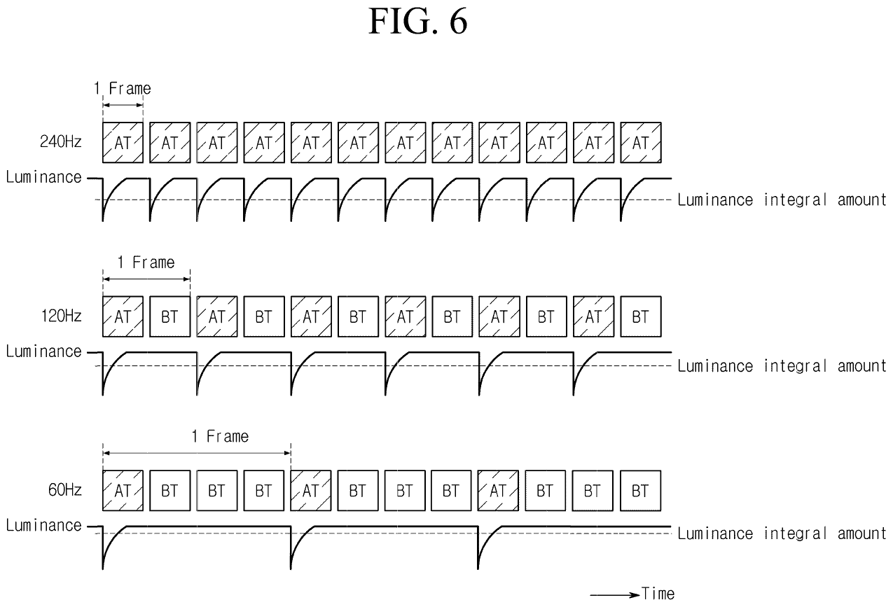

FIG. 6 is a diagram illustrating a difference in the integral amount of luminance according to the refresh rate.

Referring to FIGS. 5 and 6 together, when the length of the blank period BT increases by the operation in the variable refresh rate, the length of the light emitting period t3 and t3 in the corresponding frame increases. Therefore, when comparing the integral amount of luminance during a certain period of time, as the refresh rate is low (that is, as the length of the blank period BT is long), the integral amount of luminance relatively increases. For example, the integral amount of luminance during the certain period of time is greater at 120 Hz than that at 240 Hz, and greater at 60 Hz than that at 120 Hz.

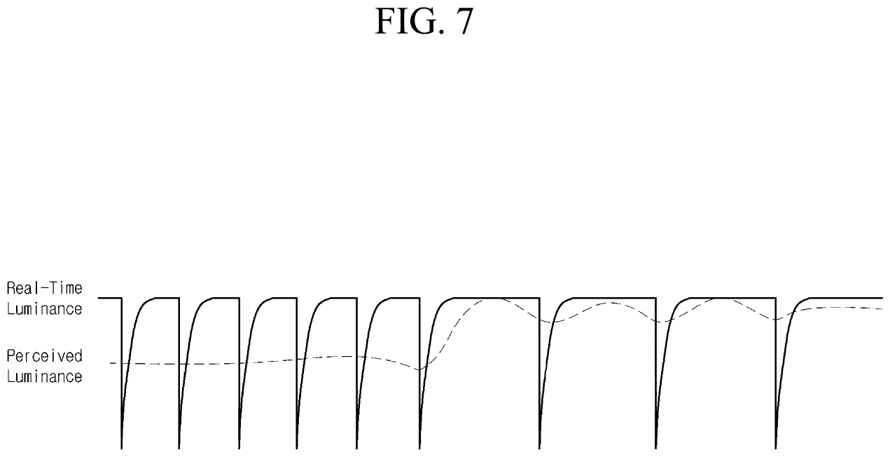

FIG. 7 is a diagram illustrating variation of recognition luminance according to a change of the refresh rate.

Referring to FIGS. 6 and 7 together, as the integral amount of luminance increases at a low frequency, the recognition luminance recognized by the user increases greatly at the low frequency. By the difference in the integral amount of luminance according to the refresh rate, the flicker may be seen to the user at a time point when the refresh rate is changed.

In an image of high luminance, the integral amount of luminance may relatively become great because luminance saturation occurs fast at a high frequency as well. That is, in an image of high luminance, a difference of the integral amount of luminance at the high frequency and at the low frequency may decrease, and the flicker may not be seen to the user.

On the other hand, luminance saturation occurs slowly at a low frequency, and a difference of the integral amount of luminance at the high frequency and at the low frequency may become great. In addition, such a difference of the integral amount of luminance may further increase as the frequency gets lowered.

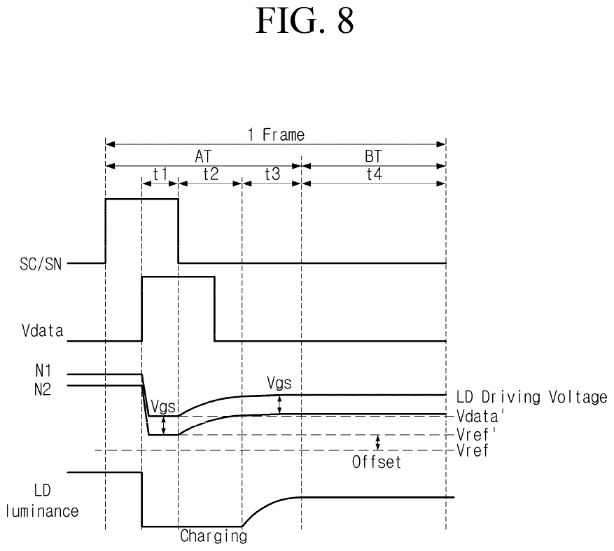

FIG. 8 is a diagram illustrating a method for driving a pixel according to one or more other embodiments of the present disclosure.

Referring to FIGS. 2 and 8 together, the pixel PX may be driven on a frame basis. One frame may include an active period AT in which an image is displayed and a blank period BT after the active period.

The active period AT may include a programming period t1, a boosting period t2, and a light emitting period t3.

In the programming period t1, the first transistor T1 may be turned on by the scan signal SC in a turn-on level, and the second transistor T2 may be turned on by the sensing signal SN in a turn-on level. In the programming period t1, a reference voltage Vref′ may be applied to the reference voltage line VrefL, and a data voltage Vdata′ may be applied to the data line DL.

Accordingly, the data voltage Vdata′ may be applied to the first node N1 of the driving transistor DT, and the reference voltage Vref′ may be applied to the second node N2 thereof. That is, in the programming period t1, the gate-source voltage of the driving transistor DT is programmed as a voltage difference between the data voltage Vdata′ and the reference voltage Vref′. The programmed voltage may be stored in the storage capacitor Cst. At this instance, the gate-source voltage has a value greater than the threshold voltage of the driving transistor DT, and the driving transistor DT may be turned on.

In one or more embodiments, the reference voltage Vref′ is a variable reference voltage, may be set lower than the driving voltage of the light emitting element LD, and may be varied on a frame basis according to the driving mode of the display device 1, the degree of deterioration of the pixel PX, and the driving frequency, etc. For example, the reference voltage Vref′ may be varied by adding a certain change amount (offset) determined according to the driving mode, the degree of deterioration of the pixel PX, and the driving frequency, etc. to an initial reference voltage Vref set at an initial driving time.

The driving mode may include, for example, a high dynamic range (HDR) mode, a standard dynamic range (SDR) mode and the like. The degree of deterioration of the pixel PX may include mobility of the driving transistor DT, a degree of a change of the driving voltage of the threshold voltage and/or the light emitting element LD. The degree of deterioration of the pixel PX may be measured through a power-on and/or power-off sequence, or measured in real time while the display is operated.

In order to generate the same driving current in correspondence with the same luminance, the gate-source voltage of the driving transistor DT must be maintained identically in correspondence with the corresponding luminance. In order to program the same gate-source voltage into the driving transistor DT with respect to the same luminance, when the reference voltage Vref′ increases or decreases by as much as an offset, the data voltage Vdata′ must increase or decrease by as much as the offset as well. Therefore, the data voltage Vdata′ compensated in correspondence with the offset of the reference voltage Vref′ may be applied to the data line DL in the programming period t1.

At this instance, when a voltage value of the compensated data voltage Vdata exceeds a set voltage range as illustrated in FIG. 4, the pixel PX may not operate properly. Therefore, the offset of the reference voltage Vref′ is determined in consideration of the voltage range of the data voltage Vdata. For example, the offset of the reference voltage Vref′ may be set in the remainder range among the voltage ranges of the data voltage Vdata illustrated in FIG. 4. This will be described in more detail with reference to the drawing below.

In the boosting period t2, the scan signal SC and the sensing signal SN are changed over to a turn-off level, and the first transistor T1 and the second transistor T2 are turned off. Then, through the driving transistor DT in a turn-on state, the driving current may be applied to the second node N2. A voltage of the second node N2 may gradually increase by the driving current. At this instance, a voltage of the first node N1 coupled to the second node N2 by the storage capacitor Cst may increase in correspondence with the voltage increase of the second node N2. Therefore, the gate-source voltage of the driving transistor DT is maintained to be a programmed voltage in the programming period t1.

When the voltage of the second node N2 increases to the driving voltage of the light emitting element LD, the light emitting element LD may be turned on in the light emitting period t3. In the light emitting period t3, the driving current corresponding to the gate-source voltage of the driving transistor DT may flow to the light emitting element LD, and the light emitting element LD may emit light at luminance corresponding to the driving current.

In the embodiment in FIG. 8, in the programming period t1, a voltage of the second node N2 is set to be a reference voltage Vref′ which is higher as much as the offset than the initial reference voltage Vref described referring to FIG. 3. Therefore, in the boosting period t2, the voltage of the second node N2 may reach the driving voltage of the light emitting element LD faster. As a result, the light emitting period t3 of the light emitting element LD may be further elongated in the one frame.

As such, the display device 1 according to one or more embodiments may reduce the length of the boosting period t2 and increase the length of the light emitting period t3 by varying the reference voltage Vref′. As the light emitting period t3 is elongated, the integral amount of luminance described referring to FIG. 6 increases. For example, when the integral amount of luminance increases by increasing the reference voltage Vref′ when the display device 1 operates at a high frequency, the difference in the integral amount of luminance according to a change of the refresh rate is reduced, and thus, the flicker may be eased.

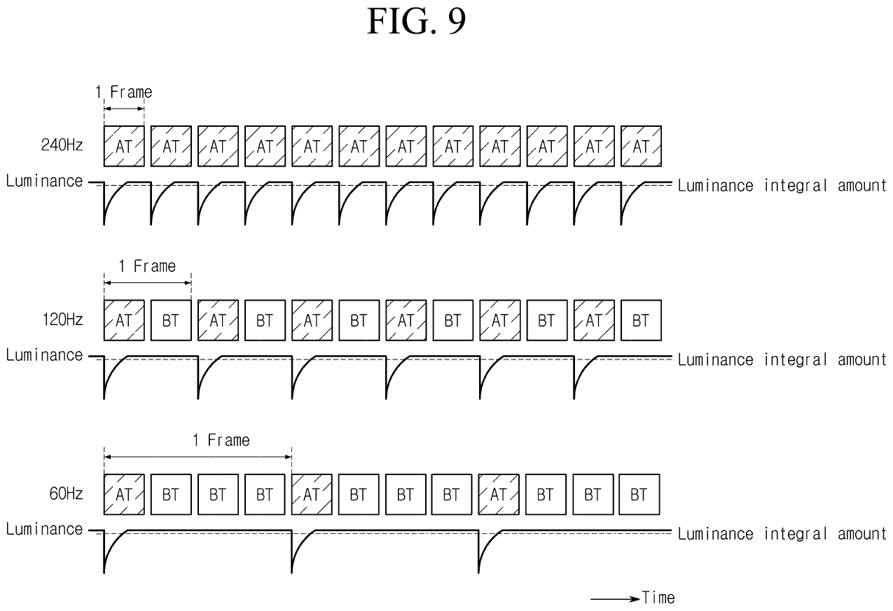

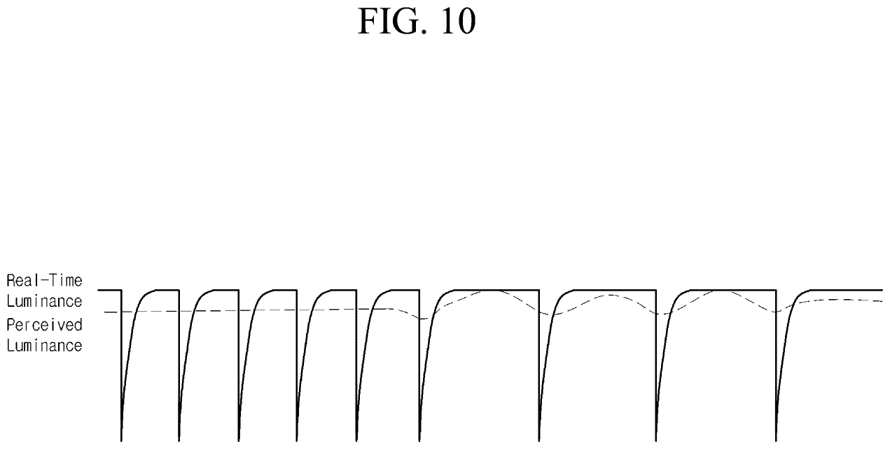

FIG. 9 is a diagram illustrating an effect of improving a difference in the integral amount of luminance according to variation of the reference voltage. FIG. 10 is a diagram illustrating an effect of improving variation of the recognition luminance according to variation of the reference voltage.

As described referring to FIG. 8, the display device 1 according to one or more embodiments may reduce the length of the boosting period t2 and increase the length of the light emitting period t3 by varying the reference voltage Vref'. As the light emitting period is elongated, the integral amount of luminance during a certain period of time increases as illustrated in FIG. 9.

For example, by increasing the reference voltage Vref′ when the display device 1 operates at a high frequency, the integral amount of luminance may increase. Then, the difference in the recognition luminance at a low frequency is reduced, and thus, the flicker due to a change of the refresh rate may be eased.

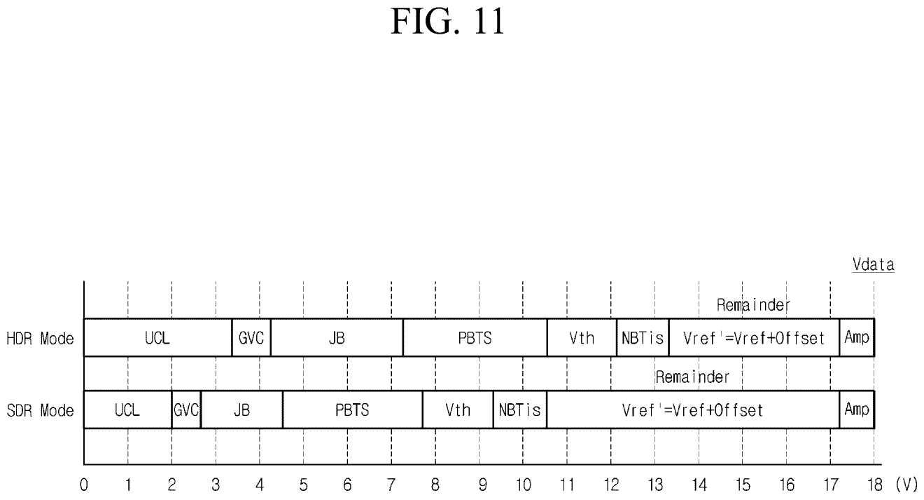

FIG. 11 is a diagram illustrating a method for setting a variable reference voltage according to a first embodiment of the present disclosure.

As described referring to FIG. 4, the data voltage Vdata may be determined in a preset voltage range. The voltage range of the data voltage Vdata may include the grayscale voltage range UCL and the compensation voltage range.

In one or more embodiments, among the voltage ranges of the data voltage Vdata, the remainder range except the grayscale voltage range and the compensation voltage range may be allocated for the reference voltage Vref′. That is, the initial reference voltage Vref and the offset may be set within the remainder range of the data voltage Vdata. For example, the reference voltage Vref′ may be determined to be the maximum voltage value allocated to the

### Remainder Range, but Is Not Limited Thereto.

As illustrated in FIG. 11, the grayscale voltage range and the compensation voltage range may be varied according to the driving mode of the display device 1. The driving mode may include, for example, the HDR mode, the SDR mode and the like. The HDR mode may be defined as a mode which maximizes or at least increases a difference between a bright portion and a dark portion in the screen. The SDR mode may be defined as a standard screen mode. The driving mode may be determined according to the kinds of the image intended to display, and may be instructed by an external host and the like.

The grayscale range is relatively more allocated so as to increase peak luminance in the HDR mode, and may be allocated relatively less in the SDR mode. In addition, the compensation voltage range, for example, the gamma compensation range GVC may be allocated relatively more in the HDR mode and may be relatively less in the SDR mode. Real time deterioration of the driving element in the HDR mode is relatively great, and therefore, the mobility compensation range JB may be allocated relatively more as well.

As the grayscale voltage range and the compensation voltage range are varied in correspondence with the driving mode, the remainder range may be varied as well. As the remainder range is varied, the reference voltage Vref′ may be varied in correspondence with the driving mode. For example, when the display device 1 is operated in the HDR mode, the reference voltage Vref′ may increase in correspondence with the remainder range, and when the display device is operated in the SDR mode, the reference voltage Vref′ may decrease in correspondence with the remainder range.

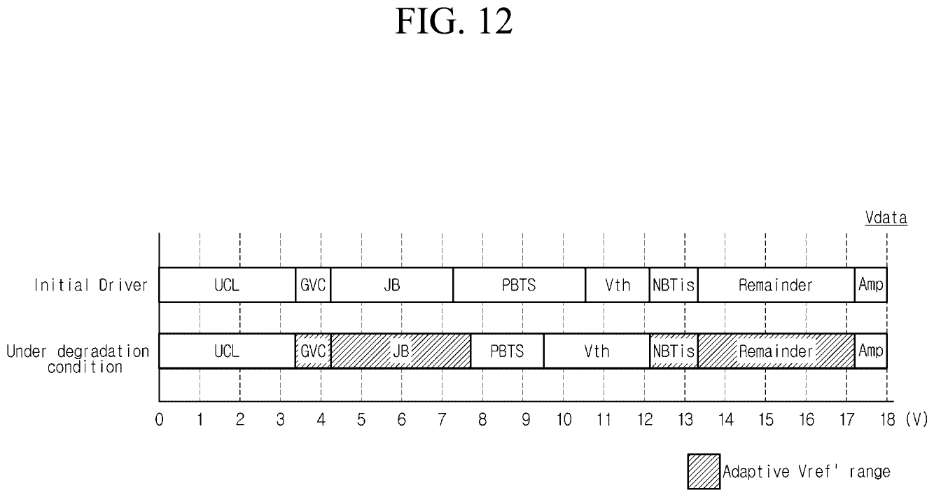

FIG. 12 is a diagram illustrating a method for setting a variable reference voltage according to a second embodiment of the present disclosure.

Referring to FIG. 12, in one or more embodiments, the compensation voltage may be varied according to the degree of deterioration of the display device 1. For example, the voltage value required for the mobility voltage compensation may increase or decrease in real time according to the degree of deterioration. In addition, a degree of a positive polarity and a negative polarity of the threshold voltage may increase or decrease in real time according to the degree of deterioration of the display device 1. Meanwhile, as the operation time of the display device 1 increases, the degree of deterioration of the threshold voltage of the driving transistor DT may increase.

When part of the compensation voltage decreases based on the degree of deterioration, part of the compensation voltage range allocated for the corresponding compensation voltage may be residual. At this instance, the residual compensation voltage range may be actively allocated for the reference voltage Vref′. For example, the residual portions of the mobility compensation range JB, the positive polarity compensation margin range PBTS, and the negative polarity compensation margin range NBTis of the compensation voltage ranges may be temporarily allocated for the reference voltage Vref′ when the corresponding compensation voltage decreases based on the degree of deterioration of the display device 1.

In more detail, when the mobility of the driving transistor DT increases in real time, the compensation voltage for the mobility compensation decreases. Therefore, only part of the mobility compensation range JB allocated for mobility compensation may be used for the mobility compensation. At this instance, a part of the remainder range may be used for the reference voltage Vref′.

Through this, the reference voltage Vref′ may increase more greatly to a voltage value exceeding the remainder range, and the voltage of the anode electrode may reach the driving voltage of the light emitting element LD faster in the boosting period t2.

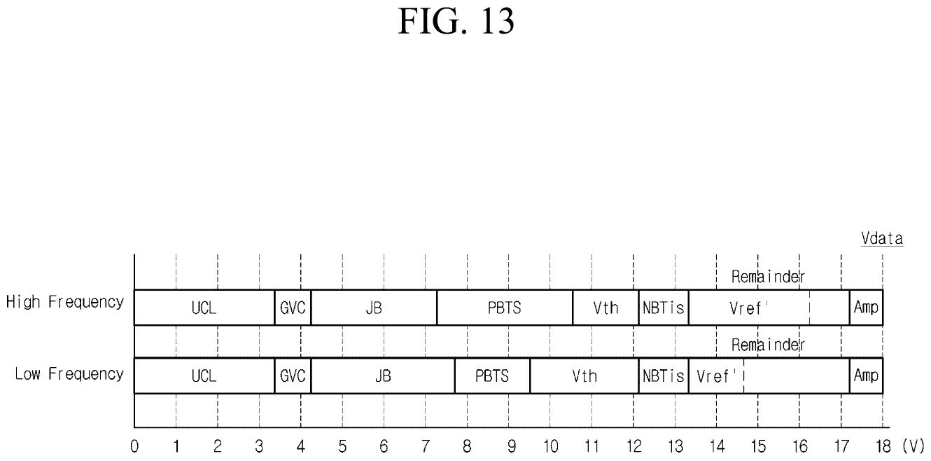

FIG. 13 is a diagram illustrating a method for setting a variable reference voltage according to a third embodiment of the present disclosure.

Referring to FIG. 13, in one or more embodiments, the reference voltage Vref′ may be set within the remainder range except the grayscale voltage range UCL and the compensation voltage range of the voltage ranges of the data voltage Vdata. At this instance, the reference voltage Vref′ may be varied within the remainder range according to the driving frequency of the display device 1.

As described referring to FIGS. 5 to 7, when the display device 1 is operated at a high frequency, a faster turn-on operation of the light emitting element LD is required so as to increase the integral amount of luminance. On contrary, when the display device 1 is operated at a low frequency, the recognition luminance increases according to the integral amount of luminance, and thus, the faster turn-on operation of the light emitting element LD is not required.

Therefore, when the refresh rate increases, the display device 1 may increase the reference voltage Vref′ in correspondence with the increasing refresh rate, and on contrary, when the refresh rate decreases, display device 1 may decrease the reference voltage Vref'.

A voltage value of the reference voltage Vref′ corresponding to the refresh rate may be preset per predetermined representative value or per section and may be stored in a form of a look-up table (LUT).

In one or more embodiments, among the voltage ranges of the data voltage Vdata, the remainder range except the grayscale voltage range and the compensation voltage range may be allocated for the reference voltage Vref′. That is, the initial reference voltage Vref and the offset may be set within the remainder range of the data voltage Vdata. For example, the reference voltage Vref′ may be determined to be the maximum voltage value allocated to the remainder range, but is not limited thereto.

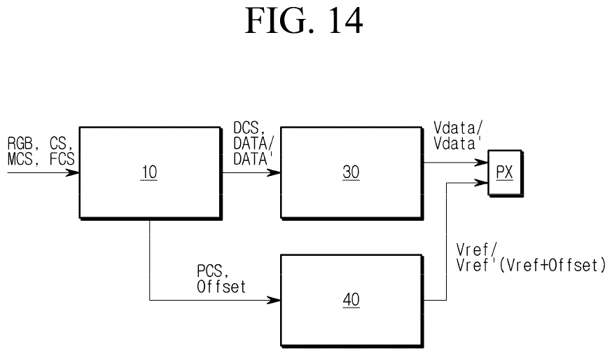

FIG. 14 is a block diagram illustrating a connection relationship among the timing controller, the data driver, and the power supply unit according to one or more embodiments of the present disclosure.

Referring to FIG. 14, the display device 1 according to one or more embodiments may include the timing controller 10, the data driver 30, and the power supply unit 40.

The timing controller 10 may receive a video signal RGB and a control signal CS from an external host system and the like. In addition, the timing controller 10 may receive a mode control signal MCS instructing an driving mode of the display device 1 instructing, for example, one among the HDR mode and the SDR mode from an external device. In addition, the timing controller 10 may receive a frequency control signal FCS instructing a driving frequency of the display device 1 from an external device.

The timing controller 10 may process the video signal RGB and may generate image data DATA according to the instructed driving mode and the driving frequency. In addition, the timing controller 10 may generate a data driving control signal DCS for controlling the data driver 30, and a power supply control signal PCS for controlling the power supply unit 40. The timing controller 10 may deliver the image data DATA and the data driving control signal DCS to the data driver 30, and may deliver the power supply control signal PCS to the power supply unit 40.

The data driver 30 may convert the image data into the data voltage Vdata according to the data driving control signal DCS and output the data voltage Vdata, and may generate the driving voltage required for operation of the pixels PX (FIG. 1) according to the power supply control signal PCS and output the driving voltage. The driving voltage may include, for example, the reference voltage Vref′.

In one or more embodiments, the timing controller 10 may control the power supply unit 40 such that the power supply unit 40 generates and outputs an initial reference voltage Vref at an initial operation. Thereafter, the timing controller 10 may control the power supply unit 40 such that the power supply unit 40 generates a reference voltage Vref′ which is varied by adding a certain offset to the initial reference voltage Vref.

In more detail, the timing controller 10 may control the power supply unit 40 such that the power supply unit 40 varies the reference voltage Vref′ according to the mode control signal MCS. For example, the timing controller 10 may vary the grayscale voltage range and the compensation voltage range in the voltage range of the preset data voltage Vdata in correspondence with a mode instructed by the mode control signal MCS. In addition, the timing controller 10 may determine a voltage value corresponding to the remainder range except the grayscale voltage range and the compensation voltage range to be a voltage value of the reference voltage Vref′.

The timing controller 10 may control the power supply unit 40 such that the power supply unit 40 generates the reference voltage Vref′ with the determined voltage value. For example, the timing controller 10 may deliver an offset corresponding to a varied amount of the reference voltage Vref′ in a predetermined control signal form to the power supply unit 40.

In one or more embodiments, the timing controller 10 may receive sensing data Vsen obtained by sensing a degree of deterioration of the pixels PX. The sensing data Vsen may be received through, for example, the data driver 30. The sensing data Vsen may include a sensing value with respect to the electric characteristic of the driving element included in the pixel PX. The sensing value may include, for example, mobility of the driving transistor DT (FIG. 2), a threshold voltage, and a driving voltage of the light emitting element LD (FIG. 2).

The timing controller 10 may perform external compensation with respect to the image data DATA based on the obtained sensing data Vsen. The timing controller 10 may determine a predetermined compensation voltage, reflect the compensation voltage to the image data DATA, and output the compensated image data DATA′. The external compensation may be performed as the data driver 30 provides the data voltage Vdata′ compensated based on the compensated image data DATA′ to the pixel PX.

In one or more embodiments, the timing controller 10 may vary the reference voltage Vref in correspondence with the compensation voltage. In more detail, the timing controller 10 may use part of the preset compensation voltage range as the determined compensation voltage, and the remainder range as the reference voltage Vref′. For example, the timing controller 10 may determine the voltage value of the reference voltage Vref′ obtained by adding the voltage range remaining in the remainder range of the above-described data voltage Vdata to the voltage value of the reference voltage Vref′.

In one or more embodiments, the timing controller 10 may control the power supply unit 40 such that the power supply unit 40 varies the reference voltage Vref′ according to the frequency control signal FCS. For example, the timing controller 10 may increase the reference voltage Vref′ when the driving frequency instructed by the frequency control signal FCS increases in the preset voltage range of the data voltage Vdata, and the timing controller 10 may decrease the reference voltage Vref′ when the driving frequency instructed thereby decreases.

When the reference voltage Vref′ according to the above-described embodiment is varied, the timing controller 10 may control the data driver 30 such that the data driver 30 varies the data voltage Vdata in correspondence with the varied amount (an offset) of the reference voltage Vref′. For example, the timing controller 10 may generate the image data DATA by reflecting the varied amount of the reference voltage Vref′, and may deliver the generated image data DATA to the data driver 30. A data voltage Vdata corresponding to the image data DATA varied by the data driver 30 may be generated.

In addition, the timing controller 10 may deliver the varied amount of the reference voltage Vref', that is, the offset, to the data driver 30 together with the image data DATA. The data driver 30 may convert the image data DATA into the data voltage Vdata, and reflect the offset to the converted data voltage Vdata and output it.

The embodiments of the present disclosure have been described with reference to accompanying drawings. Those of ordinary skill in the art will recognize that the present disclosure may be embodied in other specific forms without departing from its spirit or essential characteristics. The described embodiments are to be considered in all respects only as illustrative and not restrictive. The scope of the present disclosure is therefore indicated by the appended claims rather than by the foregoing description. All changes which come within meaning and range of equivalency of the claims are to be embraced within the scope of the present disclosure.

What is claimed is:

1. A display device, comprising:
a display panel having an arrangement of a plurality of pixels;
a gate driver configured to apply a scan signal to a first pixel of the plurality of pixels;
a data driver configured to apply a data voltage to the first pixel;
a power supply unit configured to apply a reference voltage to the first pixel; and
a timing controller configured to control an operation of the data driver and the power supply unit,
wherein the reference voltage is varied based on at least one among a driving mode of the display device, a degree of deterioration of the first pixel, and a driving frequency of the first pixel.

2. The display device of claim 1, wherein the driving frequency is varied according to a variable refresh rate mode of the display device,
wherein in the variable refresh rate mode, the first pixel is driven on a frame basis,
wherein a frame comprises:
an active period in which the data voltage is programmed into the first pixel; and
a blank period in which a programming of the data voltage is omitted, wherein
a length of the blank period is varied according to the driving frequency.

3. The display device of claim 1, wherein the driving mode comprises a high dynamic range (HDR) mode and a standard dynamic range (SDR) mode, and
wherein in a condition of a same driving frequency of the first pixel, a voltage value of the reference voltage in the HDR mode is greater than a voltage value of the reference voltage in the SDR mode.

4. The display device of claim 3, wherein the voltage value of the reference voltage varies in proportion to a driving frequency of the first pixel in a condition of a same driving mode of the display device.

5. The display device of claim 3, wherein a voltage value of the data voltage is set in a preset voltage range,
wherein the preset voltage range comprises a grayscale voltage range, a compensation voltage range and a remainder range, and
wherein a voltage value of the reference voltage is set to a value corresponding to the remainder range which is varied according to the driving mode.

6. The display device of claim 5, wherein a compensation voltage is set in the compensation voltage range, and
wherein the reference voltage is further varied in correspondence with a change amount of the compensation voltage.

7. The display device of claim 6, wherein a voltage value of the reference voltage is set by adding a remaining range of the compensation voltage range which is not used for the compensation voltage to the remainder range.

8. The display device of claim 7, wherein the compensation voltage range further allocated to the reference voltage comprises at least one among a mobility compensation range of a driving element in the first pixel, a positive polarity compensation margin range of the driving element, and a negative polarity compensation margin range of the driving element.

9. The display device of claim 5, wherein a voltage value of the reference voltage varies in proportion to the driving frequency in the remainder range.

10. The display device of claim 1, wherein the first pixel comprises:
a light emitting element;
a driving transistor having a first electrode connected to a high potential driving voltage, a second electrode connected to the light emitting element through a second node, and a gate electrode connected to a first node;
a first transistor connected between the data voltage and the first node, the first transistor configured to receive a first scan signal through a gate electrode of the first transistor; and
a second transistor connected between the reference voltage and the second node, the second transistor configured to receive a second scan signal through a gate electrode of the second transistor, and
wherein the data voltage is varied in correspondence with a change amount of the reference voltage.

11. A method for driving the display device according to claim 10, comprising:
allowing the timing controller to apply the first scan signal in a turn-on level and the second scan signal in a turn-on level in a first period of an active period of a frame;
changing the first scan signal and the second scan signal over to a turn-off level in a second period of the frame;
allowing the light emitting element to be turned on and emit light in a third period of the frame; and
allowing the light emitting element to emit light in a blank period of the frame after the active period,
wherein a length of the blank period is varied according to the driving frequency, and
wherein the reference voltage is varied on a frame basis based on at least one among the driving mode, the degree of deterioration, and the driving frequency.

12. The method for driving the display device of claim 11, wherein a voltage value of the data voltage is set in a preset voltage range,
wherein the preset voltage range comprises a grayscale voltage range, a compensation voltage range and a remainder range, and
wherein a voltage value of the reference voltage is set to a value corresponding to the remainder range.

13. The method for driving the display device of claim 12, wherein the driving mode comprises a high dynamic range (HDR) mode and a standard dynamic range (SDR) mode, and
wherein in a condition of a same driving frequency of the first pixel, a voltage value of the reference voltage in the HDR mode is greater than a voltage value of the reference voltage in the SDR mode.

14. The method for driving the display device of claim 13, wherein the voltage value of the reference voltage varies in proportion to the driving frequency in a condition of a same driving mode of the display device.

15. The method for driving the display device of claim 12, wherein a compensation voltage is set in the compensation voltage range, and
wherein the reference voltage is further varied in correspondence with a change amount of the compensation voltage.

16. The method for driving the display device of claim 15, wherein a voltage value of the reference voltage is set by adding a remaining range of the compensation voltage range which is not used for the compensation voltage to the remainder range.

17. The method for driving the display device of claim 16, wherein the compensation voltage range further allocated to the reference voltage comprises at least one among a mobility compensation range of the driving transistor, a positive polarity compensation margin range of the driving transistor, and a negative polarity compensation margin range of the driving transistor.

18. The method for driving the display device of claim 12, wherein a voltage value of the reference voltage varies in proportion to the driving frequency in the remainder range.

19. A display device, comprising:
a display panel having an arrangement of a plurality of pixels, a first pixel of the plurality of pixels including:
a light emitting element configured to emit light,
a driving transistor having a gate electrode connected to a first node, the driving transistor connected to the light emitting element through a second node;
a first transistor having a first electrode connected to a data line, a second electrode connected to the first node and a gate electrode connected to a first gate line, and
a second transistor having a first electrode connected to a reference voltage line, a second electrode connected to the second node and a gate electrode connected to a second gate line;
a gate driver configured to provide a first scan signal to the first gate line and a second scan signal to the second gate line;
a data driver configured to provide a data voltage to the data line;
a power supply unit configured to provide a reference voltage to the reference voltage line; and
a timing controller configured to control an operation of the data driver and the power supply unit,
wherein the timing controller controls the power supply unit to vary the reference voltage based on at least one among a driving mode of the display device, a degree of deterioration of the first pixel, and a driving frequency of the first pixel.

20. The display device of claim 19, wherein the timing controller controls the power supply unit to increase the reference voltage when the driving frequency changes from a first frequency to a second frequency greater than the first frequency, and
wherein the timing controller controls the power supply unit to decrease the reference voltage when the driving frequency changes from the second frequency to the first frequency.
